(19) United States
(12) Patent Application Publication
(10) Pub. No.: US 2019/0248042 A1
(43) Pub. Date: Aug. 15, 2019

(54) DROPLETIZATION APPARATUS WITH CATCHING DEVICE

(71) Applicant: MAAG AUTOMATIK GMBH, Grossostheim (DE)

(72) Inventor: Helmuth Meidhof, Grossostheim (DE)

(21) Appl. No.: 16/390,423

(22) Filed: Apr. 22, 2019

Related U.S. Application Data
(63) Continuation of application No. PCT/EP2017/001231, filed on Oct. 20, 2017.

(30) Foreign Application Priority Data
Oct. 21, 2016 (DE) 202016006519.0
Oct. 20, 2017 (WO) PCTEP2017001231

(51) Int. Cl. B29B 9/10; B29B 9/16

(52) U.S. Cl. CPC B29B 9/10; B01J 2/04; B29B 9/16

(57) ABSTRACT

A dropletization apparatus for producing granules from a melt, such as a melt for producing pharmacological granules, or a low-viscosity plastic melt of polyamides or copolyamides. The apparatus can have a caster nozzle which imparts an oscillation to the melt. Upon forming granule/droplets, the melt material can traverse an adjustable fall zone to become granules. The granule/droplets and/or granules can impact a catching device comprising a truncated cone and enter a cooling fluid. Granules can then be separated from the cooling fluid and removed for further processing.

### CROSS REFERENCE TO RELATED APPLICATIONS

The present application is a Continuation Application of co-pending International Patent Application No. PCT/EP2017/001231 filed on Oct. 20, 2017, titled “DROPLETIZATION APPARATUS WITH CATCHING DEVICE”, which claims priority to German Patent Application No. 20 2016 006 519.0 filed on Oct. 21, 2016. These references are incorporated herein in their entirety.

### FIELD

The present disclosure generally relates to a dropletization apparatus for producing granules from a melt and a corresponding catching device which enables reliable production and handling of granules or droplets from such a melt suitable for further processing.

### BACKGROUND

The present disclosure relates to a dropletization apparatus for producing granules from a melt, such as a melt for producing pharmacological granules, or a low-viscosity plastic melt of polyamides or copolyamides.

Generally speaking, granules can be produced from a melt by means of a dropletization apparatus. A typical dropletization apparatus can be filled with pressurized gas inside a dropletization head with a caster nozzle which has bores. The dropletization apparatus can have a granule or droplet catching bath in its bottom portion with a pressurized process or cooling fluid. The melt can be pressed through the caster nozzle such that the melt, which can be impacted with a harmonious pressure oscillation, forms granules or droplets which fall through a fall zone before they enter the process or cooling fluid bath.

Specifically, during the dropletization of low-viscosity plastic melts or melts used to produce pharmacological granules, the falling granules or droplets can foam up, due to their volatile components. This is undesirable, and it is critically important for ongoing processing that granules or droplets are created with and retain as spherical a shape as possible.

While this can also occur with other materials, low-viscosity plastic melts or melts used to produce pharmacological granules are particularly affected because the granules or droplets deform easily as a result of their low viscosity. Furthermore, the granules or droplets can stick to each other or clump, which is also undesirable.

The present disclosure addresses the deficiencies of the prior art by providing a dropletization apparatus for producing granules from a melt and a corresponding catching device which enables reliable production and handling of granules or droplets from such a melt suitable for further processing by simple, reliable means.

### BRIEF DESCRIPTION OF THE DRAWINGS

The detailed description will be better understood in conjunction with the accompanying drawings as follows:

FIG. 1 is a cut view of a dropletization apparatus with a catching device.

FIG. 2 is a cut view of a section of a catching device.

FIG. 3A is a side view of a catching device.

FIG. 3B is a top view of a catching device.

The embodiments of the present disclosure are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to a dropletization apparatus for producing granules from a melt and a corresponding catching device which enables reliable production and handling of granules or droplets from such a melt suitable for further processing by simple, reliable means

The dropletization apparatus can produce granules from a melt, such as a melt made from pharmacologically active substances for producing pharmacological granules or a low-viscosity plastic melt. Exemplary plastic melts include melts comprised of polyamide or copolyamides.

The dropletization apparatus can have a caster nozzle with bores, inside the caster nozzle the melt can be impacted with a harmonious pressure oscillation such that the melt exiting the bores forms granule-droplets.

Inside the dropletization apparatus there can be a fall zone in a gas space. The gas space can be filled with air or an inert gas such as nitrogen. In embodiments, the gas space can also be pressurized within the container.

Within the container, there can be a cooling zone with a cooling fluid (such as air) into which the granule-droplets fall, and a cooling fluid bath in which the formed granules are kept for a time period. The produced granules can be discharged from the container using a discharge device, and a separating device can be provided for separating the granules from the cooling fluid.

The length of the fall zone in the gas space can be adjustable to control the shape of the granule-droplets. For example, the individual granule-droplets can be molded with a spherical or essentially spherical shape before they enter the cooling fluid. A catching device can be disposed according to the embodiments after the fall zone such that the falling granule-droplets, at the point at which they enter the cooling fluid, have the lowest possible speed relative to the cooling fluid.

In embodiments, the catching device comprises a truncated cone, wherein cooling fluid can be guided to cover the truncated cone surface and run down the outside of the truncated cone lateral surface. Therefore, the granule-droplets can fall into the cooling fluid on the cover surface, which causes the cooling fluid to have a component of speed in the direction of the falling granules, such that the granules undergo the least possible deformation on impact with the cooling fluid.

The catching device can comprise a truncated cone, which has a peripheral region of the lateral surface having guiding slits arranged transverse to the center axis of the truncated cone such that the granules and/or the cooling fluid can be carried away from the catching device with a circumferential component of movement.

The center axis of the catching device can be to be understood as shown in the Figures, as a vertical axis of symmetry of the catching device. The guiding slits for the granules and/or for the cooling fluid can be provided in the bottom portion at the periphery of the catching device.

The guiding slits in the catching device can therefore fulfill the purpose of imparting an additional component of movement to the granules and/or the cooling fluid such that a spiral or helical movement of the granules and possibly also of the cooling fluid takes place. The guiding slits can cause cooling fluid to move in the circumferential direction of the catching device and hence in the cooling fluid bath. In this manner, granules and cooling fluid are mixed thoroughly and the granules can sink into the cooling fluid for a longer period of time. This effectively causes the path followed by the granules in the cooling fluid bath to be extended.

The guiding slits can run in the longitudinal direction of their extension essentially transverse to the center axis of the catching device. In embodiments, the slits can comprise a guide surface which has a flatter angle than the angle of the truncated cone in that region. Hence the granules, cooling fluid, or mixture of cooling fluid and granules guided by the guiding slits undergo(es) a change of direction. This change of direction can be impacted by an additional horizontal component of movement, which can further increase the dwell time of the granules in the cooling fluid bath and the mixing of granules and cooling fluid in the cooling fluid bath.

In embodiments, particularly effective cooling can be achieved if the guiding slits and/or the peripheral region of the lateral surface of the catching device can be immersed directly in the fluid bath, as this enables a particularly efficient link between imparted movement and the further movement within in the fluid bath.

The guiding slits can be circumferentially disposed around the peripheral region at uniform angular distances such that a uniform movement can be imparted around the periphery of the catching device. To this end, a plurality of guiding slits, such as 3 to 16 guiding slits can be circumferentially disposed in the peripheral region at uniform angular distances. In embodiments, 4 to 8 guiding slits can be utilized. In other embodiments, 4 guiding slits which are essentially distanced circumferentially from each other at an angle of 90 degrees can be utilized.

For easier adaptation to different dropletization geometries and different materials for dropletization, the catching device can be adjustable in two axes. In embodiments, the catching device is centerable, such that the point at which the granule-droplets enter the cooling fluid can be adjusted. In embodiments, the catching device can be uniformly adjustable at the periphery, and also vertically adjustable.

In embodiments, the catching device can have a truncated cone which has an at least partially curved lateral surface, such as in the shape of a concave ellipsoid.

The catching device can be vertically adjustable, such that the length of the fall zone in the gas space is adjustable, making adaptation to different melt materials for dropletization particularly easy to achieve.

The frequency of pressure oscillation within the caster nozzle determines an average diameter of the granule-droplets. To obtain particularly reliable dropletization, the apparatus should allow for pressure oscillation at a frequency such that the maximum deviation in the weight of the granules lies in the region of +/−10%.

The discharge device for removing the granules from the container can have gates, valves, and an impeller gate or similar devices known in the art. In embodiments in which the gas space is pressurized, the corresponding discharge device may also serve to reduce pressure in the cooling fluid with the granules contained therein, or to reduce pressure during removal of the granules.

In embodiments, the dropletization head can be rinseable by means of a unit provided for this purpose, such as a start-up valve. The dropletization head can be rinsed at least during start-up of the granulation.

In embodiments, the catching device of the present disclosure can be retrofitted into already existing dropletization apparatuses.

The invention will be described in more detail below with reference to the attached drawings, in which:

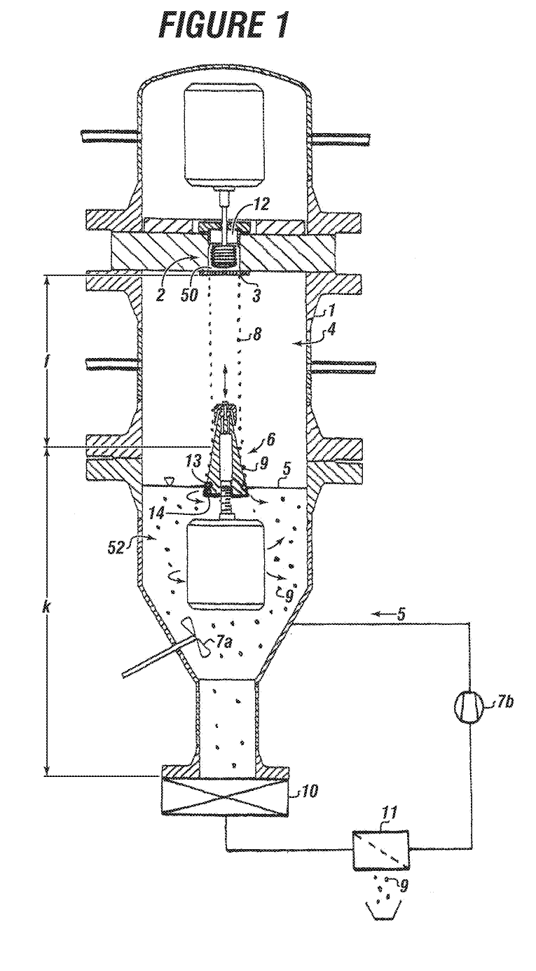

FIG. 1 is a cut view of a dropletization apparatus with a catching device.

The dropletization apparatus for producing granules 9 from a melt can have a dropletization head 2 with a caster nozzle 3. The caster nozzle can have bores which can be disposed in a ring shape, but may also be disposed in another appropriate manner, e.g. by sector.

Inside the caster nozzle 3, melt can be impacted with a harmonious pressure oscillation such that the melt exiting the bores form granule-droplets 8. The dropletization head can have a compensating space 12 and a dropletization space 50, each of which can have a certain interior pressure.

Typically, the maximum pressure difference between a gas space 4 in a container 1 of the dropletization apparatus and the compensating space 12 of the dropletization head 2 can be less than 5 bar, and preferably less than 2 bar. The pressure in the dropletization space 50 of the dropletization head 2 can be adjusted upward by at least 0.5 bar as an overpressure above ambient pressure in the gas space 4. It is preferable to limit the overpressure to 2 bar.

The granule-droplets 8 exiting the bores in the caster nozzle 3 fall inside the gas space 4 of the container 1, in which an overpressure above ambient pressure can exist. There can be a fall zone (f) in the gas space 4 and a cooling zone (k) with a cooling fluid 5.

The granule-droplets 8 can enter the cooling fluid 5 after falling through the fall zone (f) and the formed granules 9 can remain in a cooling fluid bath 52 for a period of time.

The pressure in the container 1 can be adjustable to a magnitude at least equal to the vapor pressure of any volatile substances contained in the melt, or the vapor pressure of the water contained therein.

After falling through the fall zone (f), the granule-droplets 8 can strike against a catching device 6 and enter the cooling fluid 5. The falling granule-droplets 8, at the point at which they enter the cooling fluid 5, have the lowest possible speed relative to the cooling fluid 5 due to the motion of catching device 6. The catching device 6 can comprise a truncated cone, through the inside of which the cooling fluid 5 can be guided to its cover surface and run down the outside of its lateral surface. This configuration is relatively simple, as the catching device 6 can be sealed inside the container 1 (which can be closed during operation of the apparatus).

After falling through the fall zone (f), the granule-droplets 8 can enter the cooling fluid 5 running down the outside of the lateral surface of the truncated cone. The bottom portion of the truncated cone-shaped catching device 6 can be located in the cooling fluid bath 52, and the granules 9 can be displaced from the catching device 6 further downward into the bath of cooling fluid 5 by the cooling fluid which runs down the lateral surface of the truncated cone.

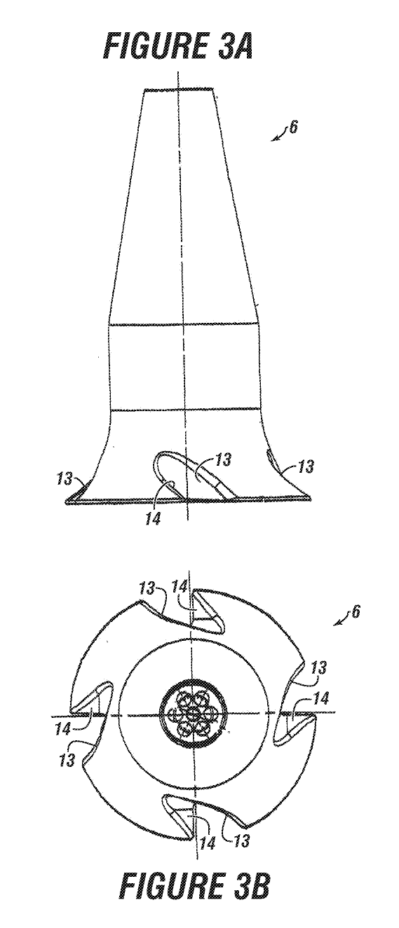

The catching device 6 can have a peripheral region of its lateral surface which has guiding slits 13, shown in greater detail in FIGS. 3A and 3B, arranged transverse to the center axis of the truncated cone. The guiding slits can allow the granules 9 and the cooling fluid 5 to be carried away from the catching device 6 in the cooling fluid bath 52 with a circumferential component of movement.

The guiding slits 13, at least partially running in the longitudinal direction transverse to the center axis, can have a guide surface 14 which has a flatter angle compared to the angle of the truncated cone. FIG. 3B shows 4 guiding slits 13 which are circumferentially disposed around the peripheral region at uniform angular distances, i.e. ninety degrees. Because of the guiding slits (13), the granules (9) dwell longer in the cooling fluid (5) or in the cooling fluid bath (52) due to the guided and additionally imparted movement of the truncated cone. The movement of the granules (9) or of the cooling fluid (5) can be spiral or helical.

Circulating devices 7a and 7b for the cooling fluid 5 can be provided both inside and outside the container 1 respectively. The circulating devices 7a and 7b aid in keeping the granules 9 or the granule-droplets 8 unclumped after impacting the cooling fluid 5, or after entering the cooling fluid 5. Granules 9 or the granule-droplets 8 can also be discharged from the container 1 with the aid of turbulence caused by circulating devices 7a and 7b.

In embodiments, only one circulating device may be provided. Persons having ordinary skill in the art can determine optimum circulation of fluid on a case-by-case basis depending on geometric and/or flow-related factors.

The circulating devices 7a and 7b can be a circulating pump or similar device known by those having ordinary skill in the art. In embodiments, a circulating device 7b disposed outside the container 1 can be connected with the container via a cooling fluid supply line.

A discharge device 10 can be provided by means of which the granules 9 can be discharged from the container 1 and the overpressure (if used) can be reduced. A separating device 11 can be provided so that the granules 9 can be separated from the cooling fluid. Downstream conveyor and/or silage means for storing or further processing of the granules 9 can be attached in cooperation with the dropletization apparatus.

In embodiments, the granules 9 are discharged from the container 1 in the cooling fluid 5 via the discharge device 10 and only then separated from the cooling fluid 5 with the separating device 11. However, in embodiments, the granules 9 may initially be separated from the cooling fluid 5 with a separating device and then be discharged from the container 1 via a discharge device 10 and the overpressure may be reduced where appropriate. This may be achieved, for example, by means of a rotary valve or similar.

In embodiments, gas space 4 can be filled with an inert gas, such as nitrogen.

The cooling zone (k) can be formed along the zone from the point of contact of the catching device 6 and the cooling fluid 5 in the cooling fluid bath 52 up to a region of the container 1.

Note that the entire dropletization apparatus can be provided with the fall zone (f) and cooling zone (k) arranged in the container 1 in a vertical disposition one under the other. This allows the apparatus to be as compact as possible.

The catching device 6 can be adjustable in two axes, preferably in a lockable fashion, such that the point at which the granule-droplets enter the cooling fluid 5 can be adjustable. The adjustment can be performed along the two horizontal spatial axes. The entire catching device 6 can be also vertically adjustable along the vertical spatial axis as indicated by the double arrow.

The adjustable catching device 6 allows a versatile apparatus, capable of handling different melt materials for dropletization and/or adjustability of the length of the fall zone (f) in the gas space 4 to adjust average granule size. The fall zone (f) in the gas space 4 being adjustable allows the individual granule-droplets 8 to also be molded with a spherical or essentially spherical shape before they enter the cooling fluid 5.

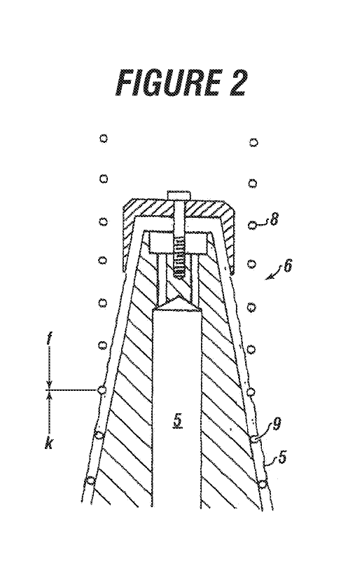

FIG. 2 is a cut view of a section of a catching device.

It can easily be seen how the granule-droplets 8 impact on the cooling fluid 5 and enter the cooling fluid 5 after passing through the fall zone (f). It can also be seen that the fall zone (f) can be sufficiently long to allow spherical or essentially spherical granule-droplets 8, and hence also granules 9, to form. Inside the truncated cone of the catching device 6, the cooling fluid 5 can be guided upward, can be redirected via a cap which defines a gap between itself and the lateral surface of the truncated cone, and then allows the cooling fluid to run down the lateral surface of the truncated cone.

FIG. 3A is a side view of a catching device.

The basic conical shape of the catching device 6 can be seen particularly well. The guiding slits 13 are shown uniformly distributed around the circumference of the catching device 6. The center axis is also shown. The transition from lateral surface to guiding slit can be configured to be continuously rounded such that a largely linear flow can be generated for the granules and/or the cooling fluid there in the region of the guiding slits and possibly also contiguously in the cooling fluid bath.

FIG. 3B is a top view of a catching device.

It can clearly be seen that four guiding slits 13 are provided there, uniformly disposed across the circumference at a ninety-degree angle. It can also be seen that the guiding slits 13 each have, at least in sections, an additional guide surface 14 which has a flatter angle compared to the angle of the truncated cone in the region there. The radial extension of the catching device 6 is also shown by axes.

FIG. 3B shows an arrangement of the guiding slits 13 transverse to the center axis of the truncated cone. This allows granules and/or cooling fluid to be carried away from the catching device with a circumferential component of movement.

The guiding slits 13 can be created by milling, casting, or any other form of manufacture known to persons having ordinary skill in the art. Overall, a catching device 6 of this type can be relatively simple in terms of construction.

While the present disclosure emphasizes the presented embodiments and Figures, it should be understood that within the scope of the appended claims, the disclosure might be embodied other than as specifically enabled herein.

What is claimed is:

1. A dropletization apparatus for producing granules from a melt, comprising:
a. a caster nozzle with a bore, inside which there is a pressure oscillation;
b. a container comprising:
(i) a fall zone with an adjustable length;
(ii) a gas space;
(iii) a cooling zone;
(iv) a cooling fluid;
(v) a cooling fluid bath; and
(vi) a catching device comprising a truncated cone
c. a discharge device; and
d. a separating device;
wherein the catching device has a peripheral region of a lateral surface comprising guiding slits arranged transversely to a center axis of the truncated cone, causing granules and/or the cooling fluid to be carried away from the catching device.

2. The dropletization apparatus of claim 1, wherein the guiding slits run in the longitudinal direction and comprise a guide surface which has a flatter angle compared to the angle of the truncated cone in the region.

3. The dropletization apparatus of claim 1, wherein the guiding slits and/or the peripheral region of the lateral surface is/are immersed in the cooling fluid bath.

4. The dropletization apparatus of claim 1, wherein the guiding slits are circumferentially disposed around the peripheral region of the lateral surface.

5. The dropletization apparatus of claim 1, wherein the guiding slits are circumferentially disposed at uniform angular distances.

6. The dropletization apparatus of claim 1, wherein there are 3 to 16 guiding slits.

7. The dropletization apparatus of claim 1, wherein there are 4 guiding slits placed ninety degrees apart from one another.

8. The dropletization apparatus of claim 1, wherein the catching device is adjustable in two axes.

9. The dropletization apparatus of claim 1, wherein the truncated cone comprises a curved lateral surface.

10. The dropletization apparatus of claim 9, wherein the curved lateral surface is in the shape of an ellipsoid.

11. The dropletization apparatus of claim 10, wherein the curved lateral surface is in the shape of an ellipsoid which is concavely curved.

12. The dropletization apparatus of claim 1, wherein the catching device is displaceable to adjust the length of the fall zone.

13. The dropletization apparatus of claim 1, wherein the gas space is filled with an inert gas.

14. The dropletization apparatus of claim 1, wherein a frequency of the pressure oscillation is adjustable.

15. The dropletization apparatus of claim 1, wherein the discharge device comprises a gate, a valve, an impeller gate, or combinations thereof.

16. A catching device of a dropletization apparatus such that falling granule-droplets, at the point at which they enter a cooling fluid, have the lowest possible speed relative to the cooling fluid.

17. The catching device of claim 16, further comprising a truncated cone, wherein the cooling fluid is guided to cover the truncated cone surface and run down the outside of the truncated cone lateral surface.

18. The catching device of claim 17, wherein the catching device has a peripheral region of a lateral surface comprising guiding slits arranged transversely to a center axis of the truncated cone.

19. The catching device of claim 17, wherein the truncated cone comprises a curved lateral surface.

20. The catching device of claim 17, wherein the curved lateral surface is in the shape of an ellipsoid.
